(19) United States
(12) Patent Application Publication
(10) Pub. No.: US 2020/0007776 A1
(43) Pub. Date: Jan. 2, 2020

(54) LENS APPARATUS AND IMAGE PICKUP APPARATUS

(71) Applicant: CANON KABUSHIKI KAISHA, Tokyo (JP)

(72) Inventor: Katsuhiko Nagata, Saitama-shi (JP)

(21) Appl. No.: 16/446,474

(22) Filed: Jun. 19, 2019

(30) Foreign Application Priority Data
Jun. 29, 2018 (JP) 2018-125521

(51) Int. Cl. H04N 5/232; H04N 5/225; G02B 7/09; G02B 7/28

(52) U.S. Cl. CPC H04N 5/23296; H04N 5/2254; G02B 7/282; G02B 7/09; H04N 5/23299

(57) ABSTRACT

An apparatus includes a focus lens unit movable for focusing, a zoom lens unit movable for zooming, and a controller configured to determine information on a target angle of view based on information relating to a position of the focus lens unit and information relating to a position of the zoom lens unit, and to perform control as control of the position of the zoom lens unit based on the information on the target angle of view and the information relating to the position of the focus lens unit. The controller is configured to perform setting of the target angle of view in a case where movement of the zoom lens unit is started by the control after the control is started.

### BACKGROUND OF THE INVENTION

### Field of the Invention

The aspect of the embodiments relates to a lens apparatus and an image pickup apparatus.

### Description of the Related Art

It is known that, in a lens apparatus, a field angle (also referred to as “an angle of view” or “an angle of field”) is changed by a focus operation. For example, when a focus target in an image is changed from an object to another object, a field angle is changed and a size of the object is changed even without performing a zoom operation. A lens apparatus that has a function to reduce, by a zoom operation, such change of the field angle caused by the focus operation has been proposed (Japanese Patent Application Laid-Open No. 2001-042199). Japanese Patent Application Laid-Open No. 2001-042199 discusses a technology that determines a target position of a zoom lens with respect to a target position of a focus lens instructed by a focus instruction, to reduce, by the zoom operation, the change of the field angle without delay.

When the reduction of the change of the field angle by the zoom operation starts, the start of the zoom operation may be delayed by backlash in a mechanism for the zoom operation. If the start is delayed, deviation of a zoom state from a target state may become excessively large. Accordingly, when an operation state is changed from a non-zoom operation state to a zoom operation state, rapid change of the field angle may occur to generate an unnatural image.

### SUMMARY OF THE INVENTION

The aspect of the embodiments is directed to, for example, a lens apparatus beneficial in reduction of change in an angle of view caused by a focus operation.

According to an aspect of the embodiments, an apparatus includes a focus lens unit movable for focusing, a zoom lens unit movable for zooming, and a controller configured to determine information on a target angle of view based on information relating to a position of the focus lens unit and information relating to a position of the zoom lens unit, and to perform first control as control of the position of the zoom lens unit based on the information on the target angle of view and the information relating to the position of the focus lens unit. The controller is configured to perform setting of the target angle of view in a case where movement of the zoom lens unit is started by the first control after the first control is started.

Further features of the disclosure will become apparent from the following description of exemplary embodiments with reference to the attached drawings.

### BRIEF DESCRIPTION OF THE DRAWINGS

FIG. 1 is a diagram (block diagram) illustrating a configuration example of a lens apparatus according to an exemplary embodiment.

FIGS. 2A, 2B and 2C are diagrams each illustrating influence of backlash applied to compensation of an angle of view.

FIGS. 3A, 3B and 3C are diagrams each illustrating reduction of influence of the backlash.

FIG. 4 is a diagram illustrating a flow of processing according to the exemplary embodiment.

FIG. 5 is a diagram illustrating a configuration example of an image pickup apparatus.

### DESCRIPTION OF THE EMBODIMENTS

An exemplary embodiment of the disclosure is described below with reference to accompanying drawings. Basically (unless otherwise noted), the same components are denoted by the same numerals in all of the drawings illustrating the exemplary embodiment, and repetitive description of the components is omitted.

### Exemplary Embodiment of Lens Apparatus

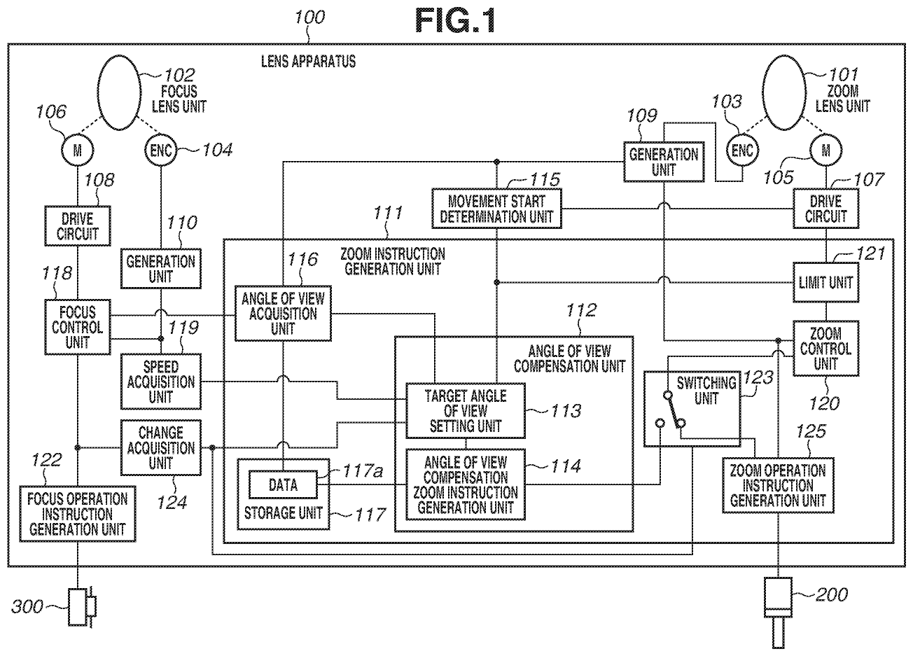

A lens apparatus according to the exemplary embodiment of the disclosure is described with reference to FIG. 1 to FIG. 4. FIG. 1 is a diagram (block diagram) illustrating a configuration example of the lens apparatus according to the present exemplary embodiment. In FIG. 1, a lens apparatus 100 includes a zoom lens unit 101 movable for zooming (magnification variation) and a focus lens unit 102 movable for focusing. A drive unit 105 (including a motor and a gear) moves the zoom lens unit 101, and a drive unit 106 (including a motor) moves the focus lens unit 102. The lens apparatus 100 can have a configuration in which at least one of the zoom lens unit 101 and the focus lens unit 102 is manually operable. A position of the zoom lens unit 101 is detected based on an output of a second detection unit 103 (which can include an encoder, and is also referred to as a first detector), and a position of the focus lens unit 102 is detected based on an output of a first detection unit 104 (which can include an encoder, and is also referred to as a second detector).

A generation unit (also referred to as a zoom follow generation unit) 109 generates position information on the zoom lens unit 101 based on the output from the second detection unit 103 (e.g., by counting pulses). A generation unit (also referred to as a focus follow generation unit) 110 generates position information on the focus lens unit 102 based on the output of the first detection unit 104 (e.g., by counting pulses). A speed acquisition unit 119 acquires speed (velocity) of the focus lens unit 102 based on the position information generated by the generation unit 110.

The second detection unit 103 is coupled to the zoom lens unit 101 through a scissors gear reduced in backlash to detect the position of the zoom lens unit 101 with accuracy. In contrast, since the drive unit 105 includes a gear having backlash, movement start of the zoom lens unit 101 may be delayed from the movement start of the drive unit 105. A movement start determination unit 115 determines the movement start of the zoom lens unit 101 based on the position information generated by the generation unit 109.

A zoom instruction generation unit 111 and a drive circuit 107 are provided to control the zoom lens unit 101. A focus control unit 118 and a drive circuit 108 are provided to control the focus lens unit 102. The drive unit 105 is driven by the drive circuit 107 that receives an instruction generated by the zoom instruction generation unit 111. The drive unit 106 is driven by the drive circuit 108 that receives an instruction generated by the focus control unit 118.

The lens apparatus 100 can be connected to a zoom operation unit 200 (also referred to as a zoom demand) that generates an operation signal relating to an instruction to control the zoom lens unit 101. Likewise, the lens apparatus 100 can be connected to a focus operation unit 300 (also referred to as a focus demand) that generates an operation signal relating to an instruction to control the focus lens unit 102. A zoom operation instruction generation unit 125 generates the instruction to control the zoom lens unit 101 (a zoom operation instruction) based on the operation signal output from the zoom operation unit 200. A focus operation instruction generation unit 122 generates the instruction to control the focus lens unit 102 (a focus operation instruction) based on the operation signal output from the focus operation unit 300. A zoom instruction generation unit 111 includes a switching unit 123 that switches the zoom operation instruction generated by the zoom operation instruction generation unit 125 and a zoom operation instruction generated by an angle of view compensation unit 112 described below.

A zoom control unit 120 generates an instruction for the drive circuit 107 based on positional deviation between the zoom operation instruction and the position information generated by the generation unit 109. The instruction generated by the zoom control unit 120 is output to the drive circuit 107 while an upper limit of the instruction is limited by a limit unit 121 as described below. The focus control unit 118 generates an instruction for the drive circuit 108 based on positional deviation between the focus operation instruction and the position information generated by the generation unit 110. A change acquisition unit 124 acquires change of the focus operation instruction generated by the focus operation instruction generation unit 122. The change acquisition unit 124 is described below.

An angle of view acquisition unit 116 acquires an angle of view of the lens apparatus 100 based on the position information on the zoom lens unit 101 generated by the generation unit 109 and the position information on the focus lens unit 102 generated by the generation unit 110. The angle of view can be acquired based on these position information and data 117a stored in a storage unit 117 (e.g., a read-only memory (ROM) such as a nonvolatile flash memory). The zoom instruction generation unit 111 includes the above-described angle of view compensation unit 112. The angle of view compensation unit 112 has a function to compensate change of the angle of view caused by movement of the focus lens unit 102 by movement of the zoom lens unit 101. The angle of view compensation unit 112 includes a target angle of view setting unit 113 to set a target value (also referred to as a target angle of view) of the angle of view in the compensation (ideally, to be constant or change of the angle of view is made to zero). The target angle of view setting unit 113 sets the target angle of view based on the angle of view acquired by the angle of view acquisition unit 116. Further, the angle of view compensation unit 112 includes a field-angle-compensation zoom instruction generation unit 114 that generates an instruction for angle of view compensation (an field-angle-compensation zoom instruction). The detail of processing by the angle of view compensation unit 112 is described below. The units 109 to 125 described above are collectively referred to as a control unit (also referred to as a controller). The control unit can include, for example, one or a plurality of processing units (a processor such as a central processing unit (CPU)). Control to the zoom lens unit 101, out of the control performed by the control unit, is also referred to as first control, and control to the focus lens unit 102 is also referred to as second control.

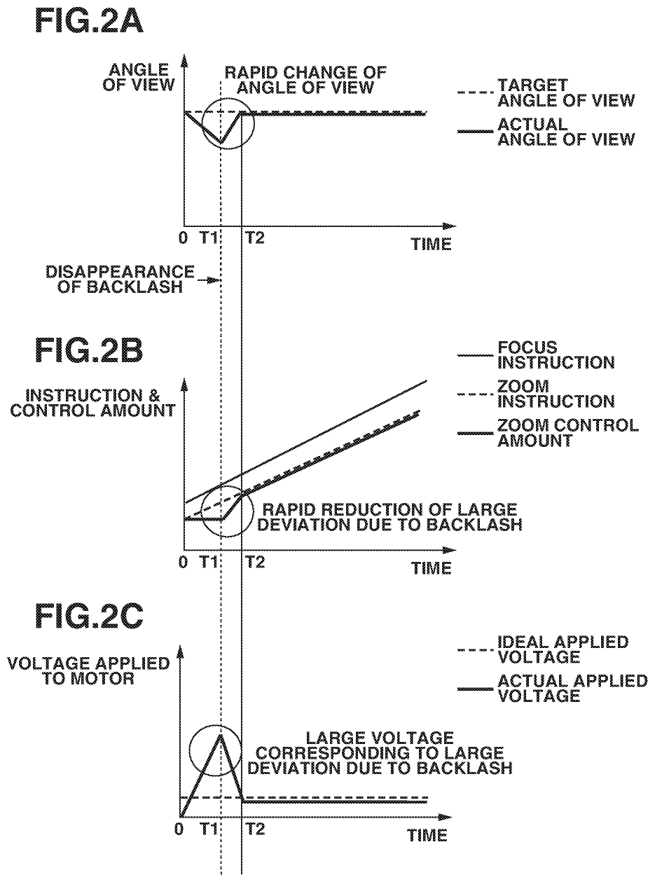

FIGS. 2A to 2C are diagrams each illustrating influence of backlash applied to compensation of the angle of view (reduction of change of the angle of view). To facilitate understanding, a focus instruction and a zoom instruction for angle of view compensation with respect to the focus instruction are both illustrated so as to be linearly changed with time (as a linear function of time). Graphs in FIGS. 2A to 2C each illustrate various kinds of amounts while a lateral axis is regarded as a time axis with the same scale. A dashed line on a time T1 indicates a time when the backlash of the drive unit 105 disappears and the movement of the zoom lens unit 101 starts. FIG. 2A illustrates the target angle of view in the angle of view compensation and an actual angle of view. FIG. 2B illustrates the focus instruction, the zoom instruction, and a zoom control amount in the angle of view compensation. FIG. 2C illustrates an ideal applied voltage and an actual applied voltage to the motor of the drive unit 105. As illustrated in FIG. 2B, during a period from a time 0 to the time T1, the zoom instruction is updated with respect to the focus instruction, but the position of the zoom lens 101 (a zoom control amount) is not changed due to the backlash in the drive unit 105. Thereafter, during a period from the time T1 to a time T2, the zoom control amount is changed to catch up the zoom instruction. Accordingly, as illustrated in FIG. 2A, during the period from the time T1 to the time T2, the angle of view is rapidly changed. During the period from the time 0 to the time T1 in which the backlash appears in FIG. 2A, the change of the angle of view caused by movement of the focus lens unit 102 appears as it is, and the angle of view compensation is not effective. Further, after the time T1 when the backlash disappears, the change of the angle of view that has not been compensated before is instantaneously compensated until the time T2. Accordingly, an image obtained by the imaging through the lens apparatus 100 may give strange feeling to a cameraperson (photographer) or a viewer of the image due to the rapid change of the angle of view during the period from the time T1 to the time T2. As illustrated in FIG. 2C, the voltage applied to the motor is continuously increased during the period from the time 0 to the time T1, and is rapidly decreased during the period from the time T1 to the time T2.

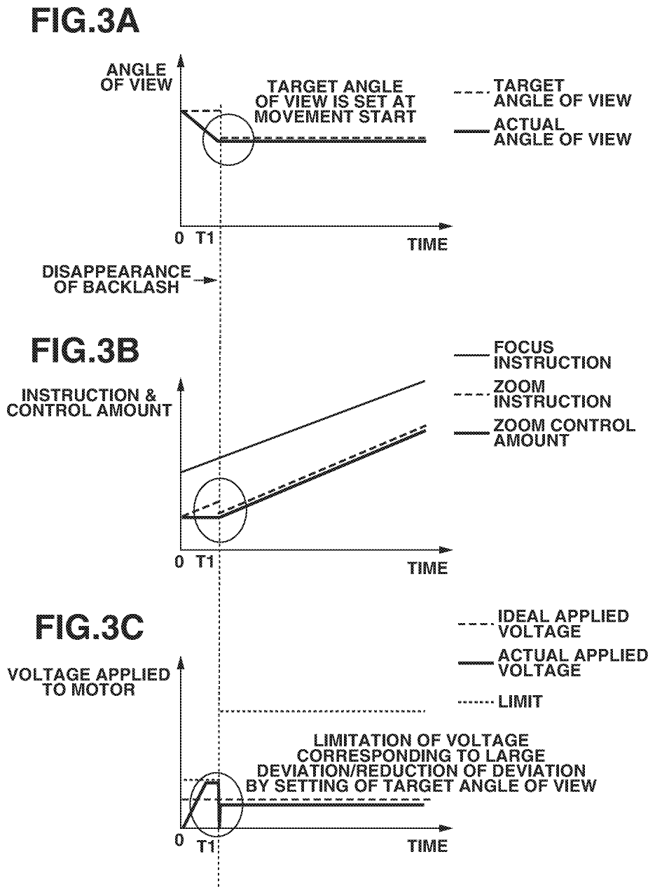

In contrast, FIGS. 3A to 3C are diagrams each illustrating reduction of the influence of the backlash according to the present exemplary embodiment. Graphs in FIGS. 3A to 3C respectively correspond to the graphs in FIGS. 2A to 2C. As illustrated in FIG. 3A, at the time T1 when the backlash in the drive unit 105 disappears (when the movement of the zoom lens unit 101 starts), the target angle of view is set (changed or reset). Thereafter, the angle of view is compensated based on the newly-set target angle of view (with the newly-set target angle of view fixed). The reset target angle can be an angle of view acquired by the angle of view acquisition unit 116, based on the position of the zoom lens unit 101 and the position of the focus lens unit 102 at the time T1 as well as the data 117a stored in the storage unit 117. Such resetting of the target angle reduces rapid movement of the zoom lens unit 101 when the appeared backlash disappears (when the movement of the zoom lens unit 101 starts), which makes it possible to reduce the above-described strange feeling given by the image. As illustrated in FIG. 3B, during the period from the time 0 to the time T1, the zoom instruction is updated with respect to the focus instruction, but the position of the zoom lens 101 (the zoom control amount) is not changed due to the backlash in the drive unit 105. Thereafter, at the time T1, the zoom instruction is changed to a zoom instruction corresponding to the position of the zoom lens unit at that time. Accordingly, as illustrated in FIG. 3C, the voltage applied to the motor does not become excessively large as illustrated in FIG. 2C, when the movement of the zoom lens unit 101 starts at the time T1. In FIG. 3C, until the backlash disappears in the drive unit 105, the applied voltage is limited to be not higher than a limit (a limit value) illustrated by a dashed line by the function of the above-described limit unit 121. When the backlash disappears (at time T1), the zoom instruction is reset as described above. Accordingly, in one embodiment, the control deviation becomes zero once, and the applied voltage also can become zero. The above-described limit is set to a value not causing (reducing) rapid movement of the zoom lens unit 101 when the backlash disappears (at time T1). Further, the above-described limit is varied to a value larger than the previous value as illustrated in the figure when the backlash disappears (after time T1). The limit while the backlash appears (during period from time 0 to time T1) can be a value previously stored in the storage unit 117. Furthermore, the limit is variable as necessary.

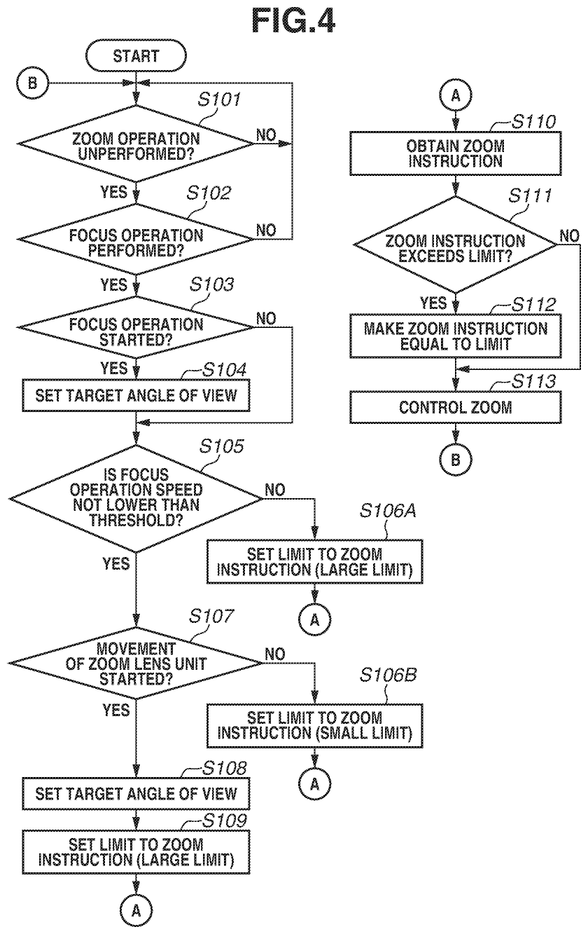

FIG. 4 is a diagram illustrating a flow of the processing according to the exemplary embodiment. In FIG. 4, in step S101, it is determined whether the zoom operation from the zoom operation unit 200 has been unperformed, based on an output from the zoom operation instruction generation unit 125. In a case where the zoom operation has been performed (NO in step S101), the processing returns to the processing immediately after START. In a case where the zoom operation has been unperformed (YES in step S101), the processing proceeds to step S102. In step S102, it is determined whether the focus operation from the focus operation unit 300 has been performed, based on an output from the change acquisition unit 124. In a case where the focus operation has not been performed (NO in step S102), the processing returns to the processing immediately after START. In a case where the focus operation has been performed (YES in step S102), the processing proceeds to step S103. In step S103, it is determined whether the focus operation has been started. In a case where the focus operation has been started (YES in step S103), the processing proceeds to step S104. In a case where the focus operation has not been started (NO in step S103), the processing proceeds to step S105. In step S104, a target angle of view in the angle of view compensation is set. In step S105, it is determined whether focus operation speed by the focus operation unit 300 is equal to or higher (i.e. not lower) than a threshold. In a case where the focus operation speed is equal to or higher than the threshold (YES in step S105), the processing proceeds to step S107. In a case where the focus operation speed is not equal to or higher than the threshold (NO in step S105), the processing proceeds to step S106A. In step S106A, a limit (a large limit) to the instruction is set. Thereafter, the processing proceeds to A. Although it is determined in step S105 whether the focus operation speed by the focus operation unit 300 is equal to or higher than the threshold, it can be determined whether the moving speed of the focus lens unit 102 is equal to or higher than a threshold. Since the above-described strange feeling given by the image may be increased as the moving speed is higher, the determination can be performed on the information on the moving speed or information having correlation with the moving speed.

In step S107, it is determined whether the movement of the zoom lens unit 101 has started. In a case where the movement of the zoom lens unit 101 has started (YES in step S107), the processing proceeds to step S108. In a case where the movement of the zoom lens unit 101 has not started (NO in step S107), the processing proceeds to step S106B. In step S106B, a limit (a small limit) to the instruction is set. Thereafter, the processing proceeds to A. In step S108, the target angle of view in a case where the movement of the zoom lens unit 101 has started is set (changed or reset). In subsequent step S109, a limit (a large limit) to the instruction is set.

Processing after A is described. In step S110, the zoom instruction is obtained (acquired). In step S111, it is determined whether the zoom instruction exceeds the limit. In a case where the zoom instruction exceeds the limit (YES in step S111), the processing proceeds to step S112. In a case where the zoom instruction does not exceed the limit (NO in step S111), the processing proceeds to step S113. In step S112, the zoom instruction is made equal to the limit. In step S113, the zoom control is performed based on the zoom instruction.

In the above-described configuration example, the zoom control using or handling the position as the control amount has been performed both before and after the movement of the zoom lens unit 101 starts (disappearance of backlash); however, the control amount is not limited thereto, and a kind of the control amount can be changed before and after the movement of the zoom lens unit 101 starts. For example, in place of the position, the zoom control using the speed as the control amount can be performed before the movement of the zoom lens unit 101 starts. Further, the focus operation has been controlled based on the signal from the focus operation unit 300. In place thereof, the focus operation can be controlled by a manual operation of an operation member included in the lens apparatus.

The above-described processing reduces the rapid movement of the zoom lens unit when the backlash disappears (when the movement of the zoom lens unit 101 starts), which makes it possible to reduce the above-described strange feeling given by the image. According to the present exemplary embodiment, it is possible to provide the lens apparatus that is beneficial to reduce the change of the angle of view caused by, for example, the focus operation.

### Exemplary Embodiment of Image Pickup Apparatus, Etc.

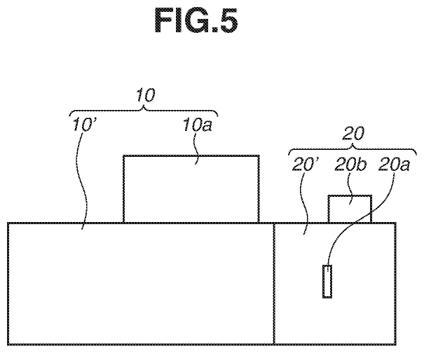

FIG. 5 is a diagram illustrating a configuration example of an image pickup apparatus. The image pickup apparatus includes the above-described lens apparatus (denoted by 10 in this example) and a camera apparatus (an imaging unit) 20 that includes an imaging device 20a disposed on an image plane of the lens apparatus. The lens apparatus 10 can include, as a sub-unit (an operation unit or a drive unit) of the lens apparatus 10, a unit 10a that includes an operation member and a CPU (a processing unit) of the lens apparatus 10. The sub-unit can be spatially separable from a body 10′ of the lens apparatus 10. In this case, an operation device (also referred to as a control device or a demand) including the unit 10a that operates (drives) a movable optical member included in the body 10′ of the lens apparatus 10 is provided. Alternatively, a drive device including the unit (a drive unit) 10a that drives the optical member is provided. The drive unit 10a can further include a motor, a drive circuit of the motor, and a detector that detects a state of the optical member. The camera apparatus 20 includes a function to transmit an instruction to the optical member. In this case, the instruction is generated by, for example, an operation device 20b (of a camera) as a sub-unit of the camera apparatus 20. Alternatively, the instruction can be generated by, for example, an autofocus function or an auto-iris function of the camera apparatus 20. The operation device 20b is separable from a body 20′ of the camera apparatus 20. Further, the operation device 20b can communicate with the body 20′ of the camera apparatus 20 through wired or wireless connection. The operation device 20b can generate at least one of an instruction corresponding to an object distance of the lens apparatus 10, an instruction corresponding to a focal length of the lens apparatus 10, an instruction corresponding to an aperture (a clear aperture or an inner diameter of a diaphragm) of the lens apparatus 10, etc. According to the present exemplary embodiment, it is possible to provide the image pickup apparatus that is beneficial to reduce the change of the angle of view caused by, for example, the focus operation.

Although the exemplary embodiments of the disclosure have been described above, the disclosure is not limited to the exemplary embodiments, and can be variously modified and alternated within the scope of the disclosure.

The disclosure can provide the lens apparatus that is beneficial to reduce the change of the angle of view caused by, for example, the focus operation.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-125521, filed Jun. 29, 2018, which is hereby incorporated by reference herein in its entirety.

What is claimed is:

1. An apparatus comprising:
a focus lens unit movable for focusing;
a zoom lens unit movable for zooming; and
a controller configured to determine information on a target angle of view based on information relating to a position of the focus lens unit and information relating to a position of the zoom lens unit, and to perform first control as control of the position of the zoom lens unit based on the information on the target angle of view and the information relating to the position of the focus lens unit,
wherein the controller is configured to perform setting of the target angle of view in a case where movement of the zoom lens unit is started by the first control after the first control is started.

2. The apparatus according to claim 1, wherein the controller is configured to perform, after the setting, the first control with the target angle of view fixed.

3. The apparatus according to claim 1, wherein the controller includes a first detector configured to detect the position of the zoom lens unit, and is configured to determine start of the movement of the zoom lens unit based on an output of the first detector.

4. The apparatus according to claim 1, wherein the controller is configured to perform the setting in the case based on the information relating to the position of the focus lens unit and the information relating to the position of the zoom lens unit.

5. The apparatus according to claim 1, wherein the controller is configured to perform the setting based on information relating to change in the position of the focus lens unit.

6. The apparatus according to claim 5, wherein the controller includes a second detector configured to detect the position of the focus lens unit, and is configured to obtain, based on an output of the second detector, the information relating to the change.

7. The apparatus according to claim 5,
wherein the controller includes a second detector configured to detect the position of the focus lens unit, and is configured to perform second control as control of the position of the focus lens unit based on an output of the second detector, and
wherein the controller is configured to obtain, based on an instruction for the second control, the information relating to the change.

8. The apparatus according to claim 5,
wherein the information relating to the change is information relating to a velocity of the focus lens unit, and
wherein the controller is configured to perform the setting in a case where the velocity exceeds a threshold.

9. The apparatus according to claim 1, wherein the controller is configured to perform two controls different from each other between a case where the movement of the zoom lens unit is started by the first control after the first control is started and a case where the movement of the zoom lens unit is not started by the first control after the first control is started.

10. The apparatus according to claim 9, wherein the two controls are different from each other in an upper limit for an instruction to the zoom lens unit.

11. The apparatus according to claim 10, wherein the controller stores the upper limit with respect to each of the two controls.

12. The apparatus according to claim 9, wherein the two controls are different from each other in a kind of a control amount.

13. The apparatus according to claim 12, wherein the controller is configured to use a velocity of the zoom lens unit as the control amount in the case where the movement of the zoom lens unit is not started, and to use the position of the zoom lens unit as the control amount in the case where the movement of the zoom lens unit is started.

14. An image pickup apparatus comprising:
an apparatus; and
an image pickup device configured to receive an image formed by the apparatus,
wherein the apparatus includes:
a focus lens unit movable for focusing;
a zoom lens unit movable for zooming; and
a controller configured to determine information on a target angle of view based on information relating to a position of the focus lens unit and information relating to a position of the zoom lens unit, and to perform first control as control of the position of the zoom lens unit based on the information on the target angle of view and the information relating to the position of the focus lens unit,
wherein the controller is configured to perform setting of the target angle of view in a case where movement of the zoom lens unit is started by the first control after the first control is started.

15. The image pickup apparatus according to claim 14, wherein the controller is configured to perform, after the setting, the first control with the target angle of view fixed.

16. The image pickup apparatus according to claim 14, wherein the controller includes a first detector configured to detect the position of the zoom lens unit, and is configured to determine start of the movement of the zoom lens unit based on an output of the first detector.

17. The image pickup apparatus according to claim 14, wherein the controller is configured to perform the setting in the case based on the information relating to the position of the focus lens unit and the information relating to the position of the zoom lens unit.

18. The image pickup apparatus according to claim 14, wherein the controller is configured to perform the setting based on information relating to change in the position of the focus lens unit.

19. The image pickup apparatus according to claim 18,
wherein the information relating to the change is information relating to a velocity of the focus lens unit, and
wherein the controller is configured to perform the setting in a case where the velocity exceeds a threshold.

20. The image pickup apparatus according to claim 14, wherein the controller is configured to perform two controls different from each other between a case where the movement of the zoom lens unit is started by the first control after the first control is started and a case where the movement of the zoom lens unit is not started by the first control after the first control is started.
